(19) United States
(12) Patent Application Publication
(10) Pub. No.: US 2006/0141200 A1
(43) Pub. Date: Jun. 29, 2006

(54) Robot cover

(76) Inventor: Mark D'Andreta, Royal Oak, MI (US)

Correspondence Address: HARNESS, DICKEY & PIERCE, P.L.C., P.O. BOX 828, BLOOMFIELD HILLS, MI, 48303, US

(21) Appl. No.: 11/295,798

(22) Filed: Dec. 7, 2005

Related U.S. Application Data
(63) Continuation of application No. 10/403,661, filed on Mar. 31, 2003.

(51) Int. Cl. B32B 3/00

(52) U.S. Cl. 428/58; 428/99

(57) ABSTRACT

A cover for an automated paint robot having a paint nozzle includes a first side panel, a second side panel, and a front panel. The front panel has a first edge secured to the first side panel and a second edge secured to the second side panel. The front panel further includes a third edge that cooperates with the first and second side panels to define a generally cylindrical opening for accommodating the paint nozzle.

### CROSS-REFERENCE TO RELATED APPLICATIONS

This application is a continuation of U.S. Ser. No. 10/403,661 filed Mar. 31, 2003. The related application is hereby incorporated by reference as if fully set forth herein.

### FIELD OF THE INVENTION

The present invention generally relates to an apparatus for protecting a paint robot from overspray paint.

### BACKGROUND OF THE INVENTION

Painted goods such as automobiles and the like conventionally utilize a dedicated paint area or paint room for the application of paint. The paint rooms are highly regulated to promote a quality paint finish. For example, most conventional clothing is prohibited due to the loose fibers which otherwise end up in the paint. Additionally, various lotions and other personal products are prohibited due to their adverse effect on the painting process.

In many applications, paint is applied to articles such as automobiles with automated paint robots. The robots advantageously eliminate human error, reduce labor and provide improved and repeatable quality. The application of paint with automated paint robots is necessarily associated with a degree of overspray. Some overspray of paint is required to ensure complete painting of the subject article.

It has heretofore been appreciated in the pertinent art that automated paint robots can be equipped with cloth covers to both protect the robot and reduce paint defects. In this regard, the cloth covers substantially shield the robots from paint overspray, thereby protecting the moving parts. Additionally, the cloth covers prevent the accumulation of paint that may otherwise result in the dripping of paint on the subject article. The covers can be periodically discarded and replaced.

Ongoing objectives in the pertinent art include improved cover fit to facilitate freedom of robot movement. It is also an ongoing objective to reduce material waste and associated labor costs.

### SUMMARY OF THE INVENTION

Accordingly, it is a general object of the present invention to provide an improved cover for an automated paint robot that furthers the pertinent art.

It is a more particular object of the present invention to provide an improved cover for an automated paint robot that reduces material waste during cover manufacturing through an efficient layout.

It is a related object of the present invention to provide a cover for an automated paint robot that reduces labor costs associated with manufacture of the cover.

It is another object of the present invention to provide an improved cover for an automated paint robot that adequately protects the robot from paint overspray without limiting required motion of the paint robot.

It is a related object of the present invention to provide a cover for an automated paint robot that minimizes the number of discrete panels that must be cut and sewn during assembly.

Other objects of the present invention include providing a cover for an automated paint robot that reduces complicated seams, pleats and darts and thereby is less expensive to produce.

In one form, the present invention provides a cover for an automated paint robot having a paint nozzle. The cover includes a first side panel, a second side panel and a front panel. The front panel has a first edge secured to the first side panel and a second edge secured to the second side panel. The front panel further includes a third edge that cooperates with the first and second side panels to define a generally cylindrical opening for accommodating the paint nozzle.

### BRIEF DESCRIPTION OF THE DRAWINGS

The present invention will become more fully understood from the detailed description and the accompanying drawings, wherein:

FIG. 1A is a front and side perspective view of a robot cover constructed in accordance with the teachings of the preferred embodiment of the present invention.

FIG. 1B is a left side view of a robot cover constructed in accordance with the teachings of the preferred embodiment of the present invention.

FIG. 1C is a rear view of a robot cover constructed in accordance with the teachings of the preferred embodiment of the present invention.

FIG. 2 is a planar view of a right side panel of the robot cover constructed in accordance with the teachings of the preferred embodiment of the present invention.

FIG. 3 is a planar view of a front side panel of the robot cover constructed in accordance with the teachings of the preferred embodiment of the present invention.

FIG. 4 is a planar view of a left side panel of the robot cover constructed in accordance with the teachings of the preferred embodiment of the present invention.

FIG. 5 is a planar view of a lower panel of the robot cover constructed in accordance with the teachings of the preferred embodiment of the present invention.

### DETAILED DESCRIPTION OF THE PREFERRED EMBODIMENT

The following description of the preferred apparatus and method of the present invention is merely exemplary in nature and is in no way intended to limit the invention, its application, or uses.

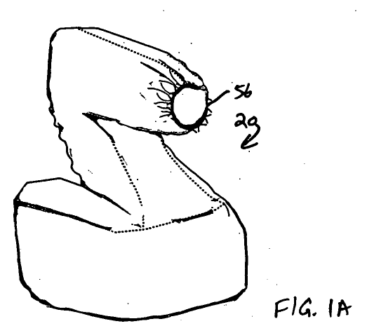

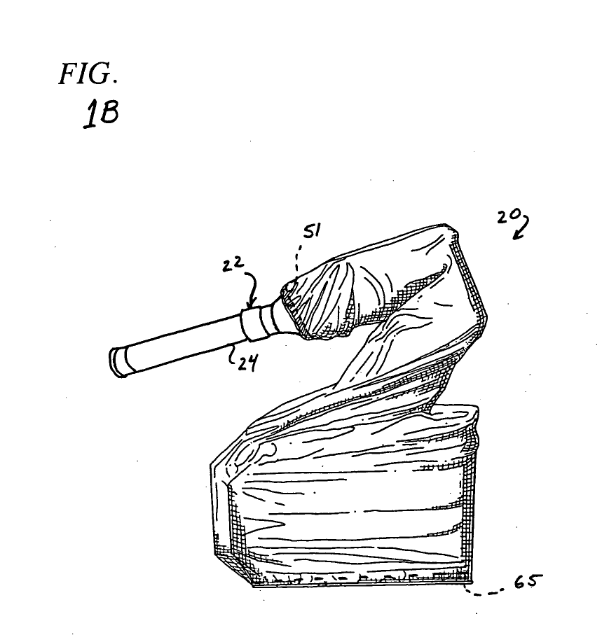

With initial reference to FIGS. 1A-1C, a cover for an automated paint robot constructed in accordance with the teachings of a first preferred embodiment of the present invention is illustrated and generally identified at reference character 20. FIG. 1A illustrates the cover 20 in an operative condition. FIGS. 1B and 1C more specifically show the cover operatively associated with a paint robot 22. A paint nozzle 24 of the robot 22 is shown extending from the cover 20 in FIG. 1B.

In the embodiment illustrated, the cover 20 is suitable for a paint robot manufactured and sold by Fanuc Robotics under the mark P-155. Those skilled in the art, however, will appreciate that various teachings of the present invention are equally applicable for covers intended for other types of paint robots.

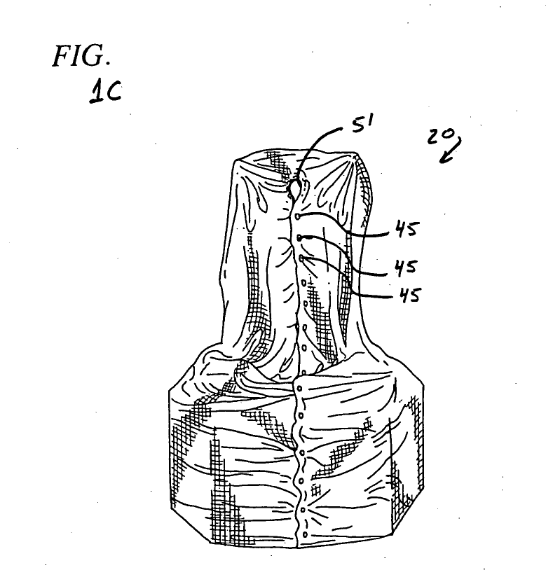

With continued reference to FIGS. 1A-1C and additional reference to FIGS. 2-5, the construction of the cover 20 will be further described. In this regard, FIG. 2 illustrates a first or right side panel 26 of the cover 20. FIG. 3 illustrates a front panel 28 of the cover 20. FIG. 4 illustrates a second or right side panel 30 of the cover 20. FIG. 5 illustrates a lower or right side panel 32 of the cover 20. Throughout FIGS. 2-5, reference numbers 2-13 are used to identify attachment points between the various panels 26-32. For example, the point on the first side panel 26 carrying the reference character 2 is secured to the point on the second side 30 similarly carrying the reference character 2. In the embodiment shown, the first side panel 26 is a mirror image of the second side panel 30.

The first panel includes an edge 34 sewn or otherwise suitably secured to an edge 36 of the front panel 28. Similarly, the second side panel 30 includes an edge 38 sewn or otherwise suitably secured to an edge 40 of the front panel 28. An upper edge 42 of the first side panel 26 is sewn or otherwise suitably secured to an upper edge 44 of the second side panel 30 at a seam that extends generally horizontal adjacent a top of the paint robot 22. A rear edge 46 of the first side panel 26 is secured to a rear edge of the second side panel 30 through a series of buttons 45. Connection between the rear edges 46 and 48 is along a rear side of the cover 20. In the embodiment illustrated, the first and second side panels 26 and 30 include notches 49 which cooperate to accommodate a hose 51 of the paint robot 22.

A forward edge 50 of the first side panel cooperates with a forward edge 52 of the front panel 28 and a forward edge 54 of the second side panel 30 to define a generally cylindrical opening 56. The generally cylindrical opening 56 accommodates the paint nozzle 24 of the paint robot 22. An inelastic band 51 (identified in FIG. 1B) is preferably employed within the cover 20 adjacent the generally cylindrical opening 56.

The lower panel 32 of the cover 20 is generally rectangular in shape. The lower panel 32 includes an upper edge 58 which is generally linear and is sewn or otherwise suitably secured to each of the first side panel 26, second side panel 30, and front panel 28. The lower panel 32 circumferentially surrounds a base of the paint robot 22. Opposing edges 61 and 63 of the lower panel 32 are buttoned, sewn or otherwise secured to one another. Again, an inelastic band 65 (identified in FIG. 1B) is preferably incorporated within the cover 20 adjacent a lower edge 64 of the lower panel 32.

In the embodiment illustrated, the front panel 28 includes a lower portion 66 which extends upward and rearward from the lower panel 32. The front panel 28 further includes an upper portion 68 which is oriented generally horizontal. The upper portion 68 cooperates with a portion 70 of the first side panel 26 and a portion 72 of the second side panel 30 to circumferentially surround the paint nozzle 24 of the paint robot 22.

The description of the invention is merely exemplary in nature and, thus, variations that do not depart from the gist of the invention are intended to be within the scope of the invention. Such variations are not to be regarded as a departure from the spirit and scope of the invention.

We claim:

1. A cover for an automated paint robot having a paint nozzle, the cover comprising:
a first side panel;
a second side panel; and
a front panel having a first edge secured to the first side panel and a second edge secured to the second side panel, the front panel further including a third edge that cooperates with the first and second side panels to define a generally cylindrical opening for accommodating the paint nozzle.

2. The cover for an automated paint robot of claim 1, wherein the first side panel is secured to the second side panel along a seam, a first portion of the seam oriented substantially vertically and disposed at a rear of the paint robot.

3. The cover for an automated paint robot of claim 1, further comprising a lower panel for circumferentially surrounding a base of the paint robot, the lower panel secured to each of the first side panel, the second side panel and the front panel.

4. The cover for an automated paint robot of claim 3, wherein the lower panel includes a substantially straight edge secured to each of the first side panel, the second side panel and the front panel.

5. The cover for an automated paint robot of claim 1, wherein the first side panel is a substantially mirror image of the second side panel.

6. The cover for an automated paint robot of claim 3, wherein the front panel includes a lower portion that extends upwardly and rearwardly from the lower panel.

7. The cover for an automated paint robot of claim 1, wherein the front panel includes an upper portion that cooperates with the first and second side panels for circumferentially surrounding the paint nozzle.

8. The cover for an automated paint robot of claim 1, wherein a second portion of the seam is oriented substantially horizontally adjacent a top of the robot.
